(19) United States
(12) Patent Application Publication
(10) Pub. No.: US 2019/0233178 A1
(43) Pub. Date: Aug. 1, 2019

(54) RECEPTACLE WITH ATTACHMENTS FOR STORAGE AND REUSE OF COOKING GREASE AND OIL

(71) Applicant: Gonzalo Rico, DeKalb, IL (US)

(72) Inventor: Gonzalo Rico, DeKalb, IL (US)

(21) Appl. No.: 16/188,211

(22) Filed: Nov. 12, 2018

Related U.S. Application Data
(60) Provisional application No. 62/624,759, filed on Jan. 31, 2018.

(51) Int. Cl. B65D 47/06; B01D 29/085; B65D 55/16; A47J 43/28; B67C 11/00

(52) U.S. Cl. CPC B65D 47/06; B01D 29/085; B67C 11/00; A47J 43/284; B65D 55/16

(57) ABSTRACT

Various embodiments relate to a cooking grease receptacle. The receptacle is configurable for depositing, filtration, storage, and/or reuse of cooking oil and grease. An example embodiment is an assembly comprising a reservoir and at least one attachment. The reservoir has a flat bottom end and a flat top end. The top end of the reservoir comprises a reservoir inlet defined by a coupling ridge. The at least one attachment has a sidewall and comprises an outlet defined by at least a portion of the sidewall. The attachment is configured to be fluidly coupled to the reservoir, via the coupling ridge, at the outlet such that a seal is formed between the attachment and the coupling ridge. Various attachments may be interchangeable such that similar coupling mechanisms across attachments are used. In some embodiments, the reservoir and the at least one attachment comprise a heat resistant material capable of withstanding temperatures of up to and including 750 degrees Fahrenheit.

### CROSS-REFERENCE TO RELATED PATENT APPLICATIONS

This application claims the benefit of priority from U.S. Provisional Application Ser. No. 62/624,759, filed Jan. 31, 2018, and the contents of which are incorporated herein by reference in their entirety.

### BACKGROUND

Generally, home chefs have no great way to dispose of grease after they have cooked. Pouring the grease directly into the sink can cause clogs and disposing of the grease directly into a trash receptacle can often melt the receptacle or cause leaking. Most chefs make use of a previously used container, such as an empty mason jar or tin can, to store the used grease and wait for it to cool and solidify before disposing of it in a trash receptacle. However, such containers can be inconvenient eyesores. They can detract from the decor of a well-designed kitchen without adding enough utility to justify their existence. Further, such containers are single-use. Which is not cost-effective or environmentally sound.

### TECHNICAL FIELD

The present disclosure relates generally to the field of receptacles. More particularly, the present disclosure relates to cooking grease receptacles for kitchens,

### SUMMARY

Various embodiments relate to a cooking grease receptacle. An example embodiment is an assembly. The assembly comprises a reservoir having a flat bottom end and a flat top end, the top end of the reservoir comprising a reservoir inlet defined by a coupling ridge. The assembly comprises at least one attachment having a sidewall, the at least one attachment comprising an outlet defined by at least a portion of the sidewall, the at least one attachment configured to be fluidly coupled to the reservoir, via the coupling ridge, at the outlet such that a seal is formed between the attachment and the coupling ridge. The reservoir and the at least one attachment comprise a heat resistant material capable of withstanding temperatures of up to and including 750 degrees Fahrenheit. In some embodiments, the heat resistant material is at least one of silicone, metal, and glass.

In some embodiments, the at least one attachment is a group comprising a first attachment and a second attachment, different from the first attachment. The first attachment has a first outlet and the second attachment has a second outlet. A first footprint of the first outlet matches a second footprint of the second outlet such that each of the first attachment and the second attachment are capable of interchangeably forming a seal around the coupling ridge of the reservoir.

In some embodiments, at least a first portion of the reservoir and at least a second portion of the at least one attachment comprises a layer composed of silicone. In some embodiments, the layer is a coating deposited on at least a portion of an outer surface of the reservoir or the at least one attachment. In some embodiments, the layer is a detachable overlay positioned adjacent to an outer surface of the reservoir or the at least one attachment.

In some embodiments, a first footprint of the inlet of the reservoir substantially matches a second footprint of the outlet of the at least one attachment.

In some embodiments, at least one attachment is a funnel. In some embodiments, the funnel is an inverted truncated cone having a funnel inlet. A first diameter of the funnel inlet is defined by a ratio of N:1 relative to a second diameter of the outlet. In some embodiments, N is set to achieve a predetermined flow rate of liquid through the funnel. In some embodiments, N is between 4 and 8 inclusive. In some embodiments, an outer surface of the funnel is corrugated. In some embodiments, the funnel comprises a splash shield. In some embodiments, the splash shied is fixedly coupled, perpendicular to a central axis of the funnel, to a sidewall of the funnel at an end of the sidewall that defines the funnel inlet.

In some embodiments, the at least one attachment is a cap. Some embodiments further include a flexible strap having a first end and a second end, wherein the first end of the strap is affixed to the reservoir and the second end of the strap is affixed to the cap.

In some embodiments, the assembly includes at least one filter having an outer edge. The filter is coupled to the reservoir and positioned proximate to the outlet defined by the coupling ridge. In some embodiments, the filter is positioned wholly inside the reservoir such that the outer edge defining the filter abuts a portion of the inner surface of the sidewall of the reservoir. In some embodiments, the at least one filter is a first filter. The assembly further includes a second filter positioned proximate to the first filter within the reservoir, wherein the second filter is separated from the first filter by a spacer.

In some embodiments, the at least one attachment comprises a pour spout.

These and other features, together with the organization and manner of operation thereof, will become apparent from the following detailed description when taken in conjunction with the accompanying drawings, wherein like elements have like numerals throughout the several drawings below.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying diagrams.

FIG. 1. is a perspective exploded view of a cooking grease receptacle and components thereof.

FIG. 2 is a perspective view of an article of manufacture representative of an embodiment of the cooking grease receptacle of FIG. 1.

FIG. 3 is a flow diagram of a method of collecting, filtering storing, and/or reusing used cooking grease via the cooking grease receptacle of FIG. 1, according to an example embodiment.

Reference is made to the accompanying drawings throughout the following detailed description. In the drawings, similar symbols typically identify similar components, unless context dictates otherwise. The illustrative implementations described in the detailed description, drawing, and claims are not meant to be limiting. Other implementations may be utilized, and other changes may be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

### DETAILED DESCRIPTION

The present disclosure relates to a cooking grease receptacle used to collect and store used cooking grease in a manner than is visually appealing, environmentally responsible, and economically efficient.

With kitchen gadgets and appliances generally, a great deal of importance is placed on the quality of the product. Chefs count on their kitchen implements to last through repeated and continuous use. As such, forcing a chef to use an old tin can to store used cooking grease is a problem within an otherwise high-quality kitchen. Other solutions to the storage and disposal of used cooking grease are equally problematic. Pouring hot cooking grease into a lined trash can be disastrous, due not only to the extremely temperature of the grease, which can melt the trash bag or receptacle, but also to the liquid nature of the grease, which can leak from even the toughest of trash bags. Alternatively, disposing of used cooking grease down the kitchen sink can ruin the pipes and cause impenetrable stoppage. Therefore, it is desirable to have a cooking grease receptacle that provides for the storage of hot cooking grease so that it can be re-used or disposed of once it has solidified. It is important that this receptacle be made of a high-quality heat-resistant material, such as silicone, in order to allow repeated and continuous use of the receptacle.

As will be appreciated, various embodiments of the present disclosure relate to a cooking grease receptacle. The receptacle is configurable for depositing, filtration, storage, and/or reuse of cooking oil and grease. An example embodiment is an assembly comprising a reservoir and at least one attachment. The reservoir has a fiat bottom end and a flat top end. The top end of the reservoir comprises a reservoir inlet defined by a coupling ridge. The at least one attachment has a sidewall and comprises an outlet defined by at least a portion of the sidewall. The attachment is configured to be fluidly coupled to the reservoir, via the coupling ridge, at the outlet such that a seal is formed between the attachment and the coupling ridge. Various attachments may be interchangeable such that similar coupling mechanisms across attachments are used. In some embodiments, the reservoir and the at least one attachment comprise a heat resistant material capable of withstanding temperatures of up to and including 750 degrees Fahrenheit.

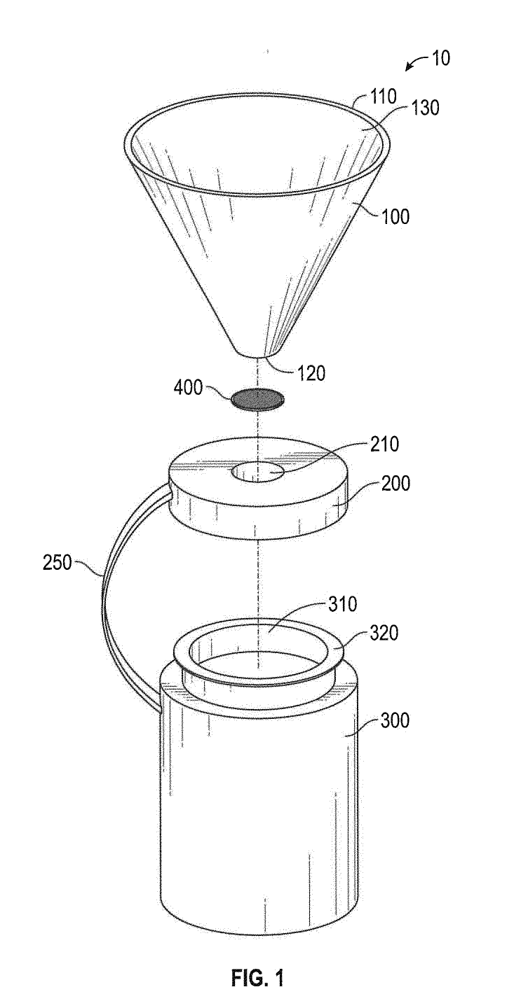

FIG. 1. is a perspective exploded view of a cooking grease receptacle 10 and components thereof, according to an example embodiment. According to various embodiments, the cooking grease receptacle 10 is structured to collect and store used cooking grease without deforming or otherwise damaging the cooking grease receptacle 10.

In the example embodiment of FIG. 1, the cooking grease receptacle 10 comprises a funnel 100, a cap 200, a strap 250, and a reservoir 300. In the example embodiment, the funnel 100 is attached, at one (e.g., bottom) end of the funnel 100, to the cap 200 or to the reservoir 300. The cap 200 is attached, at one (e.g., bottom) end of the cap 200 to one (e.g., top) end of the reservoir 300. The assembly comprises the cooking grease receptacle 10.

The funnel 100 is a pipe or a similar structure. In some embodiments, the shape of the funnel 100 is conical. The funnel 100 is structured to serve as a splash guard, preventing spillage and/or splashing of hot liquids, such as cooking oil, as the hot liquids are transferred (e,g., deposited, poured, etc.) from an external container (not shown) into the reservoir 300 via the funnel 100. In some embodiments, the funnel 100 is structured to minimize the loss of hot liquid as the hot liquid is transferred into the reservoir 300. In some embodiments, the funnel 100 is structured to control the flow of the hot liquid such that the hot liquid has an opportunity to cool down before reaching the reservoir 300.

In the example embodiment of FIG. 1, the funnel 100 comprises an inlet 110, an outlet 120, and at least one sidewall 130. The inlet 110 is structured to receive a stream of hot liquid, and the outlet 120 is structured to release the stream of hot liquid into the reservoir 300 via the filter 400. In the example embodiment, the filter 400 is attached to the cap hole 210 of the cap 200.

To prevent spillage and/or splashing, the inlet 110 is structured to be larger in size than the outlet 120. For example, in embodiments where the funnel 100 is substantially conical in shape, the inlet 110 and/or the outlet 120 may be circular, and the radius of the inlet 110 is greater than the radius of the outlet 120. In some embodiments, the ratio of the radii is between 2:1 and 4:1 such that the diameter of the inlet 110 is 4 to 8 times greater than the diameter of the outlet 120. In some embodiments, the funnel 100 is structured to achieve a target flow rate of the hot liquid through the funnel 100, and the ratio of the radii is determined accordingly. To optimize the tradeoff between the possibility of spillage and the loss of hot liquid (for example, if the liquid is poured too fast, the funnel may become clogged at the bottom, and the liquid may then flow over the top of the funnel 100) and to minimize the possibility of splashing (for example, when the liquid goes down the funnel too fast), in some embodiments, the inlet 110 is configured to achieve a first flow rate and/or a first inlet pressure at the inlet 110. The outlet 120 is configured to achieve a second flow rate and/or a second outlet pressure, different from those at the inlet 110, at the outlet 120, such that the ratio of the inlet flow rate to the outlet flow rate is within a predetermined range.

In an example embodiment where the funnel 100 is a circular cone, the height of the funnel 100 (defined as the length of the center axis of the funnel 100) is pre-determined in addition to the ratio of the radii in order to prevent the hot liquid from spilling out. In an example embodiment, the height of the funnel 100 is 3 inches, the diameter of the inlet 110 is 4 inches, and the diameter of the outlet 120 is under 4 inches (e.g., 0.5 inches.)

In some embodiments, to control the flow of the hot liquid and to allow the hot liquid to cool before it reaches the reservoir 300, the funnel 100 comprises a stern (not shown), which can be substantially cylindrical and has the same diameter as the outlet 120. In some embodiments, the volume capacity of the stem is controlled relative to the volume capacity of the funnel 100 by, for example, controlling the height of the stem. In an example embodiment, the height of the stem is at least 20% of the height of the funnel 100, including the stern.

in some embodiments, to optimize the flow of hot liquids through the funnel 100, the sidewall 130 is smooth (e.g., not creased, non-corrugated, etc.) In some embodiments, to optimize handling by the user, the outer surface of the sidewall 130 is corrugated such that it is easy for a user to grasp. In some embodiments, to increase the lifespan of the funnel 100 and to prevent the funnel 100 from being hot to the touch, the interior portion of the sidewall 130 is covered with a coating agent. In some embodiments, the coating agent is silicone-based.

Further with respect to FIG. 1, the cap 200 is a circular or similarly-shaped cover. In some embodiments, the footprint of the cap 200 has the same shape as the footprint of the reservoir inlet 310, ridge 320, or the reservoir 300. That is, if the reservoir 300 has a circular cross-section, the cap 200 similarly has a circular cross-section of substantially the same diameter.

The cap 200 is structured to be placed on another object (e.g., the reservoir 300) in order to keep whatever is inside the object from escaping. In some embodiments, the cap 200 is placed on top of the reservoir 300 to keep any hot liquids, such as cooking oil, from escaping while being stored in the reservoir. In an example embodiment, the cap 200 is removably coupled to the reservoir 300, by fitting snugly over the coupling ridge 320 of the reservoir 300, and forms a seal such that the cooking oil is forced to stay in the reservoir 300. In some embodiments, the cap 200 is a screw cap structured to attach to the reservoir 300 through continuous threads or lugs. In some embodiments, the cap 200 is a flip-top cap. In some embodiments, the cap 200 is a child-resistant closure (e.g., a push-down-to-turn cap with continuous threads, a snap cap that has release points that match a set of release points on the coupling ridge 320 of the reservoir 300, etc.).

In an example embodiment, the cap 200 includes a cap hole 210. In some embodiments, the cap hole 210 is omitted. The cap hole 210 receives the outlet 120 of the funnel 100 such that the cap 200 forms a seal with the funnel 100 so as to receive hot liquids, such as cooking grease, from the funnel 100 without spilling. In some embodiments, the diameter of the cap hole 210 matches the diameter of the outlet 120 of the funnel 100. In some embodiments, the cap hole 210 is located in the center of the cap 200, but in other embodiments, the cap hole 210 can be located anywhere on the cap 200. In some embodiments, the cap hole 210 is circular, while in other embodiments, the cap hole 210 is shaped differently (a square, a rectangle, etc.). The footprint of the cap hole 210 matches the footprint of the outlet 120 of the funnel 100. That is, the cap hole 210 is the same size as the outlet 120 such that the two parts abut each other and may have complementary sets of coupling threads, tracks, etc. In other embodiments, the cap hole 210 is larger than the outlet 120 such that the outlet 120 fits within the cap hole 210 to allow the funnel 100 to rest on top of the cap 200.

Further with respect to FIG. 1, the cooking grease receptacle 10 is shown to include the reservoir 300. The reservoir 300 comprises a reservoir inlet 310 defined by a coupling ridge 320. The reservoir 300 is structured to hold cooking grease deposited via the funnel 100. In the example embodiment shown, the reservoir 300 is substantially cylindrical. However, other embodiments are contemplated, wherein the reservoir inlet 310 is circular but the reservoir 300 itself may be shaped differently (e.g., a cube, a rectangle, a truncated cone, etc.). In some embodiments, the reservoir 300 comprises one or two handles attached to the exterior of one or more sidewalls of the reservoir 300. In some embodiments, the handles are hollow and are fluidly coupled to the body of the reservoir 300 such that the cooking grease is also deposited into the chambers defined by the hollow handles.

Tri some embodiments, the reservoir 300 is removably coupled to the cap 200. In such embodiments, the footprint (e.g., diameter, cross-section, etc.) of the reservoir inlet 310 can be equal to the footprint of the cap 200, and the cooking grease may be deposited into the reservoir 300 through the cap hole 210 of the cap 200. In other embodiments, the reservoir 300 is removably coupled to the bottom edge of the sidewall 130 that defines the outlet 120 of the funnel 100. In such embodiments, the funnel 100 may comprise a cylindrical stem with matching threads positioned on the inner or outer surface of the ridge 320 such that the funnel 100 is a screw-on funnel attachable directly to the reservoir 300. Advantageously, in such embodiments, the cap 200 and the bottom end of the funnel 100 may have the same dimensions. Thus, if the cooking grease receptacle 10 is manufactured in various sizes (e.g., for commercial versus consumer-grade applications), the parts can be more easily standardized.

Further with respect to FIG. 1, in some embodiments, a filter 400 is inserted between the funnel 100 and the cap 200. In some embodiments, the filter 400 is positioned in a suitable location between the outlet 120 of the funnel 100 and the bottom (lower) end of the reservoir 300. For example, the filter 400 may be positioned such that it covers the reservoir inlet 310 of the reservoir 300. In some embodiments, the filter 400 is substantially a network of wire (e.g., a mesh made of stainless steel or having a suitable coating, etc.) with openings sufficient for preventing various particulate matter (e.g., lumps of grease, etc.) from being deposited into the reservoir 300. In some embodiments, the filter 400 is perforated. In some embodiments, multiple filters 400 are installed to provide for multi-step filtration. The multiple filters may be separated by spacers. In some embodiments, the filter 400 is flat (e.g., a mesh or perforated screen, etc.). In other embodiments, the filter 400 is curved to prevent splashing and backflow of hot liquid through the funnel 100.

Advantageously, one or more filter(s) 400 allow cooking oil to be filtered for reuse. Furthermore, the filter 400 is more durable and efficient than conventional filtering methods, such as consumer-grade strainers, paper towels, etc. Advantageously, the filter 400 is sized such that it matches other components of the assembly.

According to various embodiments, any of the various components of the cooking grease receptacle 10 can be composed of glass, heat-resistant silicone or similar material. Advantageously, silicone has a low thermal conductivity, meaning that silicone is able to maintain its properties and structure at high temperatures without becoming unbearably hot. As such, forming the funnel 100, cap 200, reservoir 300, filter 400, etc. of heat-resistant silicone ensures that the cooking grease receptacle 10 will not only keep its shape but also be able to be handled without protection. Furthermore, and advantageously, hot cooking grease can be transferred to the cooking grease receptacle 10 without the need to wait for the cooking grease to cool down, thus saving end users time and providing a user-friendly experience.

In some embodiments, the cooking grease receptacle 10 can withstand temperatures in the range of up to 750 degrees Fahrenheit, which allows the cooking grease receptacle 10 to be used for disposal of cooking oils and fats with high smoke points immediately or shortly after use. The smoke points of various common cooking oils and fats are listed below:

| | Smoke Point | Smoke Point |
|---|---|---|
| Cooking Oils/Fats | ° C. | ° F. |
| Unrefined flaxseed oil | 107° C. | 225° F. |
| Unrefined safflower oil | 107° C. | 225° F. |
| Unrefined sunflower oil | 107° C. | 225° F. |
| Unrefined corn oil | 160° C. | 320° F. |
| Unrefined high-oleic sunflower oil | 160° C. | 320° F. |
| Extra virgin olive oil | 160° C. | 320° F. |
| Unrefined peanut oil | 160° C. | 320° F. |
| Semi-refined safflower oil | 160° C. | 320° F. |
| Unrefined soy oil | 160° C. | 320° F. |
| Unrefined walnut oil | 160° C. | 320° F. |
| Hemp seed oil | 165° C. | 330° F. |
| Butter | 177° C. | 350° F. |
| Semi-refined canola oil | 177° C. | 350° F. |
| Coconut oil | 177° C. | 350° F. |
| Unrefined sesame oil | 177° C. | 350° F. |
| Semi-refined soy oil | 177° C. | 350° F. |
| Vegetable shortening | 182° C. | 360° F. |
| Lard | 182° C. | 370° F. |
| Macadamia nut oil | 199° C. | 390° F. |
| Canola oil (Expeller Pressed) | 200° C. | 400° F. |
| Refined canola oil | 204° C. | 400° F. |
| Semi-refined walnut oil | 204° C. | 400° F. |
| High quality (low acidity) | 207° C. | 405° F. |
| extra virgin olive oil | | |
| Sesame oil | 210° C. | 410° F. |
| Cottonseed oil | 216° C. | 420° F. |
| Grapeseed oil | 216° C. | 420° F. |
| Virgin olive oil | 216° C. | 420° F. |
| Almond oil | 216° C. | 420° F. |
| Hazelnut oil | 221° C. | 430° F. |
| Peanut oil | 227° C. | 440° F. |
| Sunflower oil | 227° C. | 440° F. |
| Refined corn oil | 232° C. | 450° F. |
| Palm oil | 232° C. | 450° F. |
| Palm kernel oil | 232° C. | 450° F. |
| Refined high-oleic sunflower oil | 232° C. | 450° F. |
| Refined peanut oil | 232° C. | 450° F. |
| Semi-refined sesame oil | 232° C. | 450° F. |
| Refined soy oil | 232° C. | 450° F. |
| Semi-refined sunflower oil | 232° C. | 450° F. |
| Olive pomace oil | 238° C. | 460° F. |
| Extra light olive oil | 242° C. | 468° F. |
| Ghee (Clarified Butter) | 252° C. | 485° F. |
| Rice Bran Oil | 254° C. | 490° F. |
| Refined Safflower oil | 266° C. | 510° F. |
| Avocado oil | 271° C. | 520° F. |

Furthermore, forming various components of heat-resistant silicone also facilitates disposal of cooled cooking grease because silicone's lower rigidity enables the reservoir 300 to be squeezed in order to force the cooled cooking grease out of the reservoir 300. In some embodiments, the cap 200 and/or the funnel 100 do not need to be squeezed like the reservoir 300, and, therefore, the lower rigidity of silicone is less necessary, so a rigid heat-resistant material, such as glass or metal (copper, aluminum, steel, etc.), can be used.

In one example embodiment, the height of the funnel 100 is 3 inches from the base of the lid, the height of the reservoir 300 is 7.75 inches (such that the ratio of the height of the reservoir to the height of the funnel is 2:1 or higher), the volume capacity of the reservoir 300 is 16 fl oz, and the diameter of the bottom flat footprint of the substantially cylindrical reservoir 300 is 3 inches.

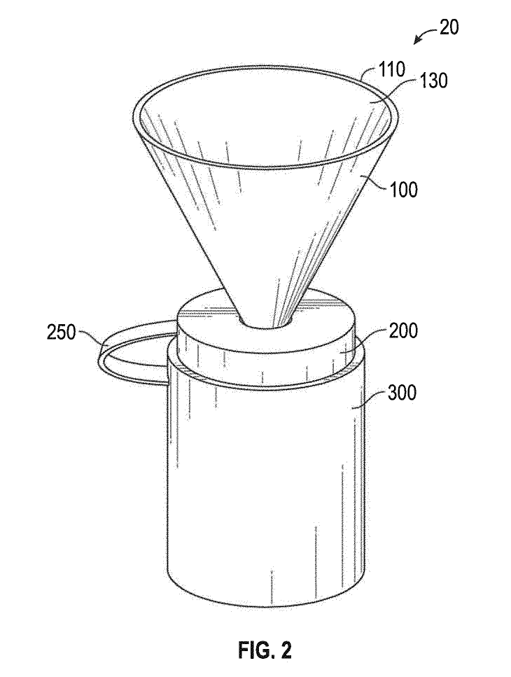

FIG. 2 a perspective view of an article of manufacture 20 representative of an embodiment of the cooking grease receptacle 10 of FIG. 1. The article of manufacture 20 is one example configuration of an assembly that defines the cooking grease receptacle 10 of FIG. 1.

As shown, the article of manufacture 20 comprises all of the components of FIG. 1, including the funnel 100, cap 200, reservoir 300, and the strap 250 that connects the cap 200 with the reservoir 300. The article of manufacture 20 may also include one or more filter(s) 400 of FIG. 1.

One skilled in the art will appreciate that other embodiments of the article of manufacture 20 are within the scope of the present disclosure. For example, in some embodiments, the strap 250 is omitted. In some embodiments, the funnel 100 can be attached directly to the reservoir 300, bypassing the cap 200. In some embodiments, the reservoir 300 may be further configured to include a removable bottom portion such that the reservoir 300 may be coupled with industrial waste-disposal systems through an additional outlet. In sonic embodiments, the article of manufacture 20 may include an additional attachment for transferring previously collected oil to a receptacle adapted for cooking, such that the oil may be reused. The additional attachment may be a rigid (non-bendable) container with an open top that includes a pour spout, a pour spout that attaches directly to the reservoir inlet 310 of the reservoir 300, a soft squeezable container, etc.

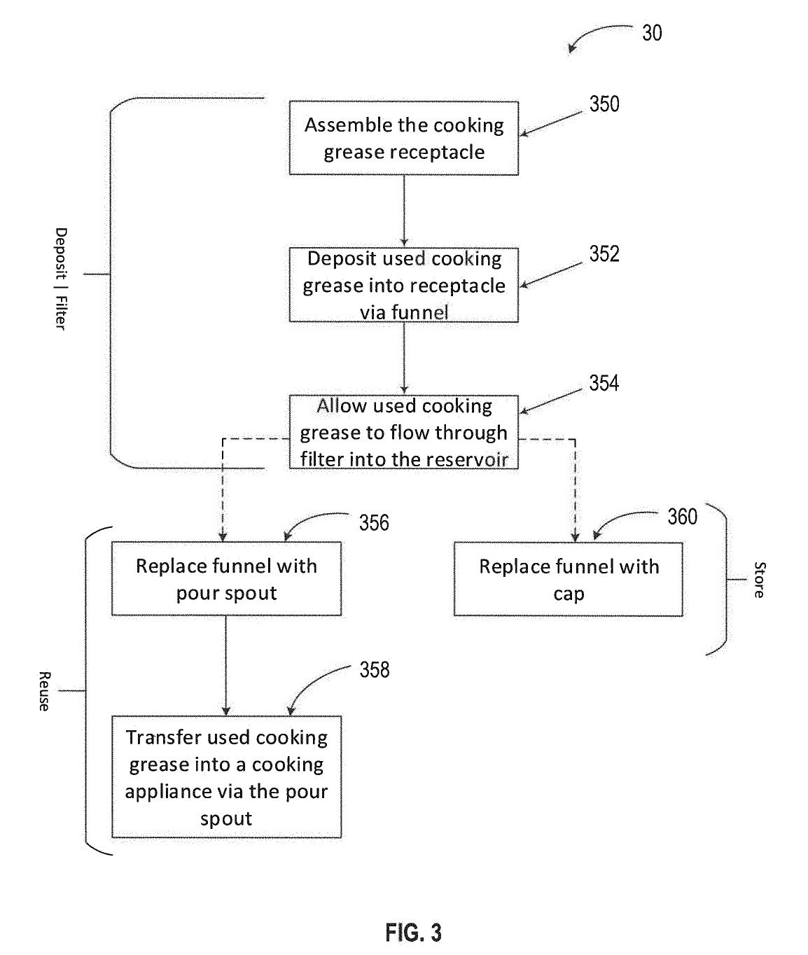

FIG. 3 is a flow diagram of a method 30 of collecting, storing, and/or reusing used cooking grease via the cooking grease receptacle 10 of FIG. 1, according to an example embodiment. In the example embodiment, various attachments can be used with the reservoir 300 in order to deposit, filter, store, and/or reuse cooking grease and oil. According to various embodiments, the operations of the method 30 can be performed by the end user of the cooking grease receptacle 10 (e.g., cook, consumer, etc.). In some embodiments, some operations of method 30 can be performed by a manufacturer and/or assembly facility. For example, the cooking grease receptacle 10 can be distributed as a pre-assembled item and/or can include end-user instructions on how to affix various removable attachments (e.g., the funnel 100, cap 200, filter 400, a pour spout (not shown), etc.) to the reservoir 300 in order to facilitate depositing, filtration, storage, and/or reuse of cooking grease and oil.

As shown, example operations 350-354 of the method 30 allow the user to deposit cooking grease and oil into the reservoir 300. In some embodiments, the operations 350-354 allow the user to filter cooking grease and oil through the filter 400 such that particulate matter is removed.

At 350, the cooking grease receptacle 10 is assembled. For example, the reservoir 300 may be removably coupled to the cap 200. In some embodiments, the cap 200 fits snugly over the coupling ridge 320 of the reservoir 300 and forms a seal such that the cooking grease and oil is forced to stay in the reservoir 300. In some embodiments, the funnel 100 is removably coupled to the reservoir 300 and/or to the cap 200. In some embodiments, the cooking grease receptacle 10 further includes the filter 400.

At 352, cooking oil and grease are deposited into the reservoir 300 via the funnel 100 and, at 354, the cooking oil and grease are allowed to flow into the reservoir 300. In some embodiments, the cooking oil and grease are filtered via one or more filter(s) 400 before reaching the reservoir 300 and/or while flowing into the reservoir 300.

Cooking oil and grease may be produced in the preparation of food and may reach a temperature within a range of 225-520 degrees Fahrenheit or higher. As the cooking oil and grease are deposited into the reservoir 300, the oil comes in contact with various parts of the funnel 100, particularly with the interior surfaces of one or more sidewalk thereof, the stem thereof, etc. The oil further comes in contact with any of the following: the filter 400, the cap 200, and the interior sidewalls of the reservoir 300. In some embodiments, the funnel 100, cap 200, reservoir 300, and/or filter 400 are made of or comprise heat-resistant material that allows the respective component of the cooking grease receptacle 10 to withstand high temperatures of up to 750 degrees Fahrenheit without melting or being substantially deformed. The material may comprise heat-resistant plastics, heat-resistant silicone, heat-resistant glass, metal, etc.

As shown, example operations 356-358 of the method 30 allow the user to reuse the cooking grease and oil previously deposited into the reservoir 300.

At 356, the funnel 100 may be decoupled from the reservoir 356. Optionally, the funnel 100 may be replaced with a pour spout (not shown) to facilitate the transfer of used cooking oil and grease out of the reservoir 300. In other embodiments, the funnel 100 itself may comprise a pour spout and may remain attached to the reservoir 300 such that the transfer of oil is facilitated via the funnel 100.

At 358, filtered cooking oil and grease may be transferred by the user into a cooking appliance to be reused. Subsequently, the reused cooking oil and grease may be re-deposited into the reservoir 300 for filtration and subsequent reuse, for example, by performing the operations 350-345.

As shown, example operation 360 of the method 30 allows the user to configure the cooking grease receptacle 10 for storage of the oil and grease previously deposited into the reservoir 300. For example, at 360, the assembly may be reconfigured for storage by decoupling the funnel 100 (or another attachment) from the reservoir 300 and replacing the funnel 100 (or another attachment) with the cap 200, in some embodiments, the filter 400 is installed such that it does not interfere with the placement of the cap 200 and may remain part of the assembly. For example, the filter 400 may be installed inside the reservoir 300 rather than at the coupling ridge 320. In some embodiments, the filter 400 may be removed by the user (e.g., for cleaning) prior to attaching the cap 200 to the reservoir 300.

In some embodiments, in order to minimize wait time until the oil cools down and the assembly can be reconfigured, any of the funnel 100 (or another attachment), filter 400, etc. may include non-metal parts (e.g., handles, etc.) or coating comprised of a low-conductivity material, such as silicone, plastic, wood, etc. For example, the filter 400 may be a strainer that comprises one or more heat-resistant surfaces, ridges, handles, etc. The funnel 100 may comprise a handle, which may be attached, for example, to the outer edge of defining the inlet 110, etc.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various example embodiments without departing from the scope of the present invention.

It should be noted that any use of the term “example” herein to describe various embodiments is intended to indicate that such embodiments are possible examples, representations, and/or illustrations of possible embodiments (and such term is not intended to connote that such embodiments are necessarily extraordinary or superlative examples).

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

What is claimed is:

1. An assembly comprising:
a reservoir having a flat bottom end and a flat top end, the top end of the reservoir comprising a reservoir inlet defined by a coupling ridge; and
at least one attachment having a sidewall, the at least one attachment comprising an outlet defined by at least a portion of the sidewall, the at least one attachment configured to be fluidly coupled to the reservoir, via the coupling ridge, at the outlet such that a seal is formed between the attachment and the coupling ridge;
wherein the reservoir and the at least one attachment comprise a heat resistant material capable of withstanding temperatures of up to and including 750 degrees Fahrenheit.

2. The assembly of claim 1, wherein the at least one attachment is a group comprising a first attachment and a second attachment, different from the first attachment, the first attachment having a first outlet and the second attachment having a second outlet, wherein a first footprint of the first outlet matches a second footprint of the second outlet such that each of the first attachment and the second attachment are capable of interchangeably forming a seal around the coupling ridge of the reservoir.

3. The assembly of claim 1, wherein the heat resistant material is at least one of silicone, metal, and glass.

4. The assembly of claim 1, wherein at least a first portion of the reservoir and at least a second portion of the at least one attachment comprises a layer composed of silicone.

5. The assembly of claim 4, wherein the layer is a coating deposited on at least a portion of an outer surface of the reservoir or the at least one attachment.

6. The assembly of claim 4, wherein the layer is a detachable overlay positioned adjacent to an outer surface of the reservoir or the at least one attachment.

7. The assembly of claim 1, wherein a first footprint of the inlet of the reservoir substantially matches a second footprint of the outlet of the at least one attachment.

8. The assembly of claim 1, wherein the at least one attachment is a funnel.

9. The assembly of claim 8, wherein the funnel is an inverted truncated cone having a funnel inlet, and wherein a first diameter of the funnel inlet is defined by a ratio of N:1 relative to a second diameter of the outlet.

10. The assembly of claim 9, wherein N is set to achieve a predetermined flow rate of liquid through the funnel.

11. The assembly of claim 9, wherein N is between 4 and 8 inclusive.

12. The assembly of claim 8, wherein an outer surface of the funnel is corrugated.

13. The assembly of claim 8, wherein the funnel comprises a splash shield.

14. The assembly of claim 13, wherein the splash shied is fixedly coupled, perpendicular to a central axis of the funnel, to a sidewall of the funnel at an end of the sidewall that defines the funnel inlet.

15. The assembly of claim 1, wherein the at least one attachment is a cap.

16. The assembly of claim 15, further comprising a flexible strap having a first end and a second end, wherein the first end of the strap is affixed to the reservoir and the second end of the strap is affixed to the cap.

17. The assembly of claim 1, further comprising at least one filter having an outer edge, wherein the filter is coupled to the reservoir and positioned proximate to the outlet defined by the coupling ridge.

18. The assembly of claim 1, wherein the filter is positioned wholly inside the reservoir such that the outer edge defining the filter abuts a portion of the inner surface of the sidewall of the reservoir.

19. The assembly of claim 1, wherein the at least one filter is a first filter, the assembly further comprising a second filter positioned proximate to the first filter within the reservoir, wherein the second filter is separated from the first filter by a spacer.

20. The assembly of claim 1, wherein the at least one attachment comprises a pour spout.
